(19) United States
(12) Patent Application Publication
(10) Pub. No.: US 2008/0000654 A1
(43) Pub. Date: Jan. 3, 2008

(54) Quick hitch

(76) Inventor: Allen Schwitzer, Melville (CA)

Correspondence Address: Mr. Allen Schwitzer, R.R. # 1, Melville, SK, S0A 2P0, US

(21) Appl. No.: 11/446,384

(22) Filed: Jun. 5, 2006

(51) Int. Cl. A01B 59/06

(52) U.S. Cl. 172/439

(57) ABSTRACT

A hydraulic maneuvered draw bar hitch assembly for a safe connection from a three-point hitch on a farm tractor to the normal vertical pin in the clevis assembly of a towed farm vehicle which entraps the clevis pin, by sliding a male protruded apparatus horizontally behind the aforementioned pin through the female orifice mounted on the main drawbar where it is held closed by the hydraulic power assembly in an engaged position until the operator decides to disengage the clevis pin by withdrawing the male protrusion from the female orifice.

### FIELD OF THE INVENTION

The present invention relates to the quick coupling of a mounted tractor type implement to a towed implement such as a work vehicle or farm implement.

### BACKGROUND OF THE INVENTION

Equipments such as farm and construction tractors may be continuously attached and unattached to several implements in a week. These implements are attached to the tractor in various configurations. The most common configuration is wherein the tow vehicle, in this case the tractor, is equipped with a three-point hitch assembly, which contains the regulator such as the human eye to hand co-ordination with a hydraulic inducer that promotes the attached drawbar assembly to be raised and lowered with respect to the towed vehicles clevis height.

The main difficulty with such tow vehicles is the lack of a safe simplified economic hitching assembly to allow the operator to automatically control the complete hitching apparatus from the driver's seat.

Several systems for attaching an implement to a tractor are described as follows:

U.S. Pat. No. 5,779,429 illustrates a system for quickly attaching an implement to a tractor. This device includes an elongated rectangular channel to which four hooks extend upward. The device is fixed to the tractor and the implement rests on the four upwardly extending hooks.

U.S. Pat. No. 3,876,092 illustrates an implement connecting coupler mechanism that is structured generally as a four bar linkage having one bar coupled to the frame of the tractor and the opposing bar of the linkage configured to be rapidly connected to an implement. A hydraulic cylinder is coupled to and extends between the two links to permit the implement link to be raised and lowered with respect to the tractor.

U.S. Pat. No. 5,779,329 is directed to a mechanism allowing quick implement attachment to tractors. It includes a framework of a laterally extending rectangular tubular member that is fixed to two vertically extending members at each end of the tubular member. These vertically extending members have hooks at their upper ends and lower ends that face upward to receive laterally extending tubular structures of an implement. The framework is fixed to the ends of jointed arms that extend outward from the rear of a tractor and hold the implement to the ends of the arm. Latches extending across the open tops of the upper hooks hold the implement in place.

U.S. Pat. No. 6,533,319 is directed to a ballast attachment for attaching a ballast to a rear three-point hitch of a tractor. A rod extends longitudinally between the two lower arms of a three-point hitch. A downwardly-facing notch or groove in a ballast, receives the rod and rests upon it. In this manner the three-point hitch supports the ballast.

U.S. Pat. No. 5,427,399 is directed to a power operated, draw bar mounted hitch for connection to the tongue of a farm implement has a fixed draw pin and a bottom hammer strap that engages under the tongue and raises the tongue onto the draw bar, where it is captured in place between the bottom hammer straps and a top hammer strap mounted on the draw bar. The hitch has an automatic self locking feature that locks the hitch when it reaches the engaged position.

None of the proceeding references provide a simple efficient system for safely and efficiently attaching to a common three-point hitch system on the back of the common tractor chassis to quickly couple to the farm implement eliminating the need for human help in the danger zone between the implements.

What is needed is a safe automatic hitching assembly attached to the three-point hitch of the rear of a tractor for coupling an implement directly to the said tractor. It is the object of this invention to satisfy the previously mentioned necessity by providing an assembly that solves requirements described above.

### SUMMARY OF THE INVENTION

According to the main aspect of the invention there is provided an attachment apparatus for coupling a draw bar of a towing tractor to the open mouthed clevis and pin of a towed vehicle, said apparatus comprising a drawbar attachment between the outer lower rails of a three-point hitch, a stationery female attachment rigidly welded to the drawbar; a sliding male attachment controlled horizontally by a hydraulic ram between its retracted stage for release and its engaged position whereby it traps the vertical pin encompassed in the open-mouth clevis, leveling braces attached to the upper ram of the three-point hitch and to the lower outer parts of the drawbar, characterized in that: In the disengaged position the towing vehicle can be backed up to the implement to be towed with the sliding male attachment open with the ram extended to its full length all the while adjusting the height by the three-point hitch upper ram until the clevis pin is positioned inside the orifice between the open male attachment and the female assembly on the rigid drawbar, thereby creating the perfect situation, whereby the sliding male drawbar attachment is closed to trap the open mouthed clevis pin inside ,thereby completing the hitch operation between the towing tractor and towed implement to complete the engaged position.

This quick hitch is controlled by the operator's use of the tractor hydraulics.

### BRIEF DESCRIPTION OF THE DRAWINGS

In the accompanying drawings, which represent an exemplary embodiment of the present invention.

FIG. 1 is a top elevation of one embodiment of the apparatus before attaching to tractor.

FIG. 2 is a rear view of the apparatus of FIG. 1, after attachment to tractor.

FIG. 3 is a side view of the apparatus in a disengaged position as it is lined up to the towing implement clevis assembly.

FIG. 4 is a side view of the apparatus in an engaged position.

### DETAILED DESCRIPTION OF THE PREFERRED EMBODIMENTS

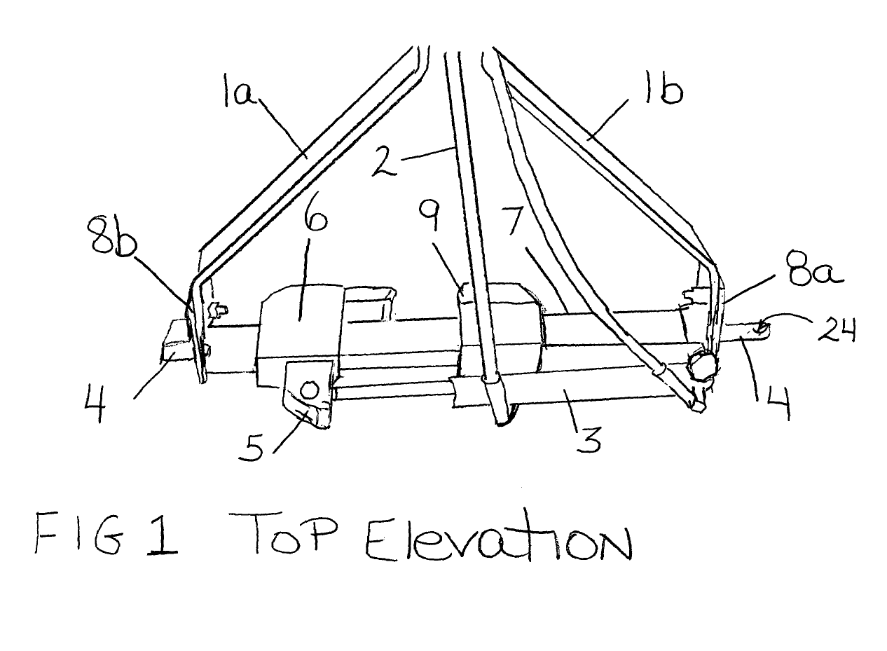

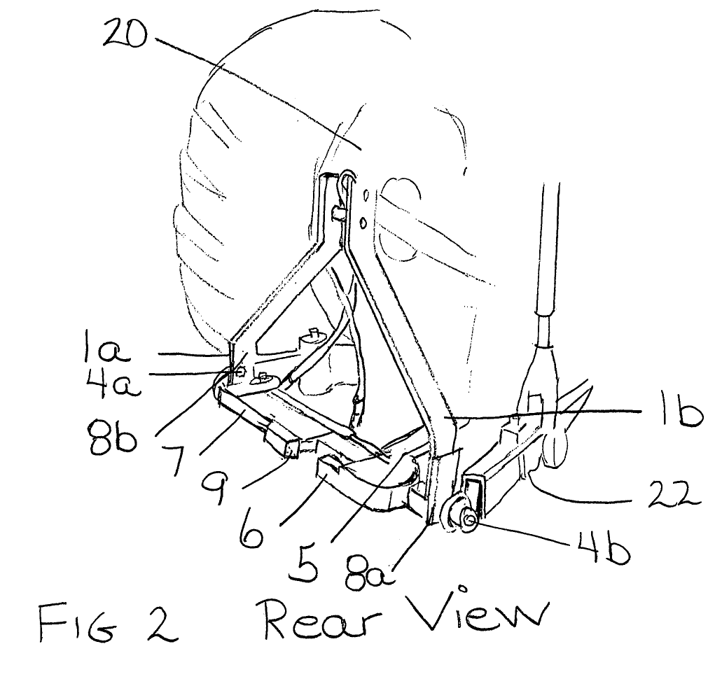

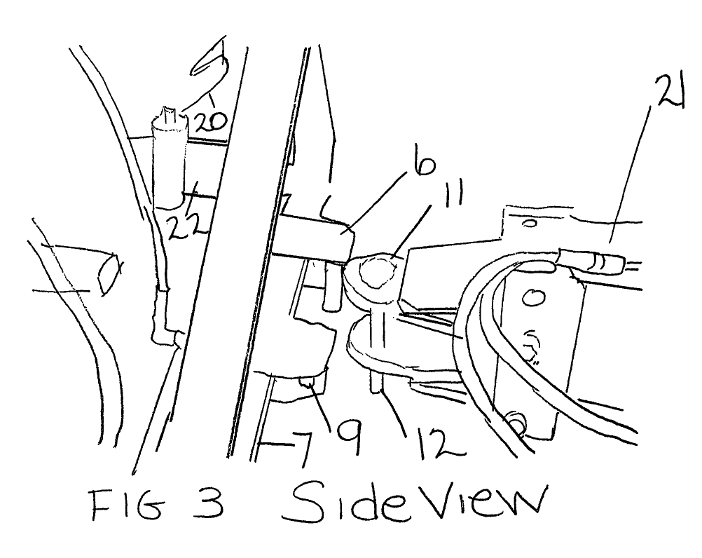

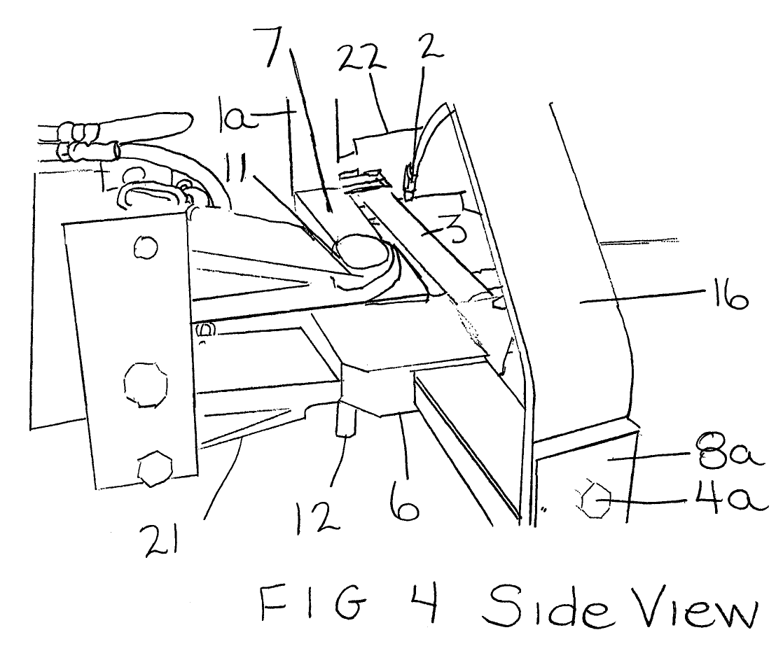

Referring to FIGS. 1-4, a tow vehicle, shown as tractor 20 in FIGS. 2 and 3, has a three-point hitching structure 22 attached to it. The quick hitch female drawbar assembly 7 is attached to the outer lower rails of the three-point hitch 22 by the pivot connector rods 4a and 4b that are welded onto each end of the female drawbar assembly 7. Each of these two pins is fixed in place by snap pins that are installed through predrilled holes 24 that are situated at both ends of the drawbar assembly 7. These snap pins prevent the drawbar from being withdrawn once they are in place vertically. Leveling braces 1a and 1b are mounted on opposite ends of the horizontal drawbar assembly 7 by bolt hardware to the vertical parallel plated leveling bar brackets 8a and 8b at the bottom and to the three-point hitch leveling ram at the top, again mounted by nut and bolt hardware.

This hitch is also provided with a sliding male attachment 6 that is projected horizontally from the disengaged position with the hydraulic cylinder ram 3 fully extended to the engaged position with the same hydraulic cylinder ram 3 fully compressed. The female flange assembly 9 is mounted to the rear of the main drawbar assembly 7 in a position whereby the sliding male assembly 6 can slide into it providing a clamping device for the vertically position drawbar pin 12 through the clevis assembly 11 of the towed implement 21. The sliding male drawbar assembly is driven by the expansion and contracting of the hydraulic cylinder 3 through the male hydraulic cylinder connector assembly 5 which is welded to the tractor 20 side of the sliding male attachment. The hydraulic hoses 2 are hooked to the tractor's hydraulic system which is controlled by the operator.

While certain embodiments of the invention have been described in the aforementioned, it is to be contemplated that other embodiments are possible within the scope of the present invention. Since various modifications could be made in my invention as herein above described, and many apparently widely different embodiments of same made with the spirit and scope of the claims with department from such spirit and scope, it is intended that all matter contained in the accompanying specification shall be interpreted as illustrated only and not in a limiting sense.

I claim:

1) A quick hitch attachment system for coupling a tractor having an existing three-point hitch system, to the front normal hitch pin and clevis arrangement of the towed implement, said apparatus comprising; a main female drawbar, a horizontal sliding apparatus with a male protrusion which interlock into the stationery female orifice mounted on the previously mentioned main drawbar assembly designed to entrap the vertical clevis pin in the tongue of a towed vehicle, a hydraulic cylinder and associated hoses required to manipulate the male attachment assembly, a male hydraulic cylinder connection assembly, a three-point hitch connection rods providing the mounting means to the lower rails of the three-point hitch leveling bar brackets welded to the opposite ends of the main drawbar assembly to allow means to connect the leveling braces onto.

2) The system of claim 1 wherein the centre part of the female drawbar is located precisely where the male protrusion of the horizontal sliding bar would trap the towed vehicle clevis pin during the engaged mode.

3) The system of claim 1 wherein the horizontal sliding apparatus includes a male protrusion which interlocks into the rigid female orifice of the main drawbar to entrap the towed vehicles clevis pin to complete the desired engaged position.
